(19) United States
(12) Patent Application Publication
(10) Pub. No.: US 2025/0010344 A1
(43) Pub. Date: Jan. 9, 2025

(54) WASTE TREATMENT FACILITY

(71) Applicant: MITSUBISHI HEAVY INDUSTRIES, LTD., Tokyo (JP)

(72) Inventors: Akira Noma, Tokyo (JP); Kazuhiro Kawai, Tokyo (JP); Yosuke Nakagawa, Tokyo (JP); Kazuki Nishizawa, Tokyo (JP); Kairi Yamada, Tokyo (JP); Terumasa Harada, Tokyo (JP); Kiyonori Kushioka, Tokyo (JP)

(73) Assignee: MITSUBISHI HEAVY INDUSTRIES, LTD., Tokyo (JP)

(21) Appl. No.: 18/701,977

(22) PCT Filed: Nov. 8, 2022
(86) PCT No.: PCT/JP2022/041469

§ 371 Date: Apr. 17, 2024

(30) Foreign Application Priority Data
Nov. 12, 2021 (JP) 2021-184843

(51) Int. Cl. B09B 3/45

(52) U.S. Cl. CPC B09B 3/45

(57) ABSTRACT

A waste treatment facility includes a storage unit configured to store waste, at least one treatment facility configured to perform intermediate treatment of part of the waste stored in the storage unit, a hydrothermal treatment device configured to hydrolyze remaining part of the waste stored in the storage unit with steam to produce a modified substance, and a treatment condition setting device configured to acquire process data of the hydrothermal treatment device, estimate an index for setting a treatment condition for intermediate treatment of the waste in the at least one treatment facility in accordance with the process data, and set the treatment condition in accordance with the index.

### TECHNICAL FIELD

The present disclosure relates to a waste treatment facility.

The present application claims priority based on Japanese Patent Application Number 2021-184843 filed to Japanese Patent Office on Nov. 12, 2021, the content of which is incorporated herein by reference.

### BACKGROUND ART

A waste treatment facility includes a treatment facility that performs intermediate treatment of waste and is often configured to perform the intermediate treatment under suitable conditions. For example, when the waste treatment facility is a garbage incineration facility, it adopts automatic combustion control for automatically adjusting the amount of garbage to be supplied to an incinerator (treatment facility) and the amount of combustion air. Patent Document 1 discloses a technique for calculating a dust feeding speed of a dust feeder that feeds garbage to an incinerator in accordance with a lower calorific value of the garbage (lower calorific value of high accuracy and lower calorific value of low accuracy).

### CITATION LIST

### Patent Literature

Patent Document 1: JP 2017-180971 A

### SUMMARY OF INVENTION

### Technical Problem

However, the technique described in Patent Document 1 calculates the lower calorific value of high accuracy from the relationship between heat input and heat output of the incinerator and calculates the lower calorific value of low accuracy from the composition of the exhaust gas generated by garbage incineration. That is, since the supply amount of garbage is set after the garbage is incinerated, control of the supply amount of the garbage to the incinerator is delayed, and the operating state of the incinerator may become unstable.

The present disclosure has been made in view of the above-described problems, and an object is to provide a waste treatment facility that can stabilize the operating state of a treatment facility.

### Solution to Problem

To achieve the above object, a waste treatment facility according to the present disclosure includes: a storage unit configured to store waste; at least one treatment facility configured to perform intermediate treatment of part of the waste stored in the storage unit; a hydrothermal treatment device configured to hydrolyze remaining part of the waste stored in the storage unit with steam to produce a modified substance; and a treatment condition setting device configured to acquire process data from the hydrothermal treatment device, estimate an index for setting a treatment condition for intermediate treatment of the waste in the at least one treatment facility in accordance with the process data, and set the treatment condition in accordance with the index.

### Advantageous Effects of Invention

The waste treatment facility of the present disclosure can stabilize the operating state of the treatment facility.

### BRIEF DESCRIPTION OF DRAWINGS

FIG. 1 is a view schematically illustrating a configuration of a waste treatment facility (incineration facility) according to a first embodiment.

FIG. 2 is a schematic functional block diagram of an incineration condition setting device according to the first embodiment.

FIG. 3 is a view for describing an example of a configuration for acquiring each of a waste feed amount and a steam supply amount according to the first embodiment.

FIG. 4 is a view schematically illustrating a configuration of an incineration facility according to a second embodiment.

FIG. 5 is a view schematically illustrating a configuration of a composition identification device according to the second embodiment.

FIG. 6A is a view illustrating a model of a hydrothermal treatment balance equation according to the second embodiment.

FIG. 6B is a view illustrating a first map according to the second embodiment.

FIG. 6C is a view illustrating a list of process measurement values according to the second embodiment.

FIG. 6D is a view illustrating a list of unknowns according to the second embodiment.

FIG. 6E is a view illustrating a result of estimating a composition and percentage of water content of waste according to the second embodiment.

FIG. 7 is a view schematically illustrating a configuration of a composition identification device according to a modification example of the second embodiment.

FIG. 8 is a view illustrating a second map according to the modification example of the second embodiment.

FIG. 9 is a view schematically illustrating a configuration of an incineration facility according to a third embodiment.

FIG. 10 is a view schematically illustrating a configuration of a supply device according to the third embodiment.

FIG. 11 is a view schematically illustrating a configuration of a supply device according to a modification example of the third embodiment.

FIG. 12 is a view schematically illustrating a configuration of an incineration facility according to a fourth embodiment.

### DESCRIPTION OF EMBODIMENTS

Hereinafter, a waste treatment facility according to embodiments of the present disclosure will be described with reference to the drawings. Such embodiments illustrate one aspect of the present disclosure, does not limit the present disclosure, and can be arbitrarily changed within the scope of the technical idea of the present disclosure.

### First Embodiment

### Configuration of Waste Treatment Facility

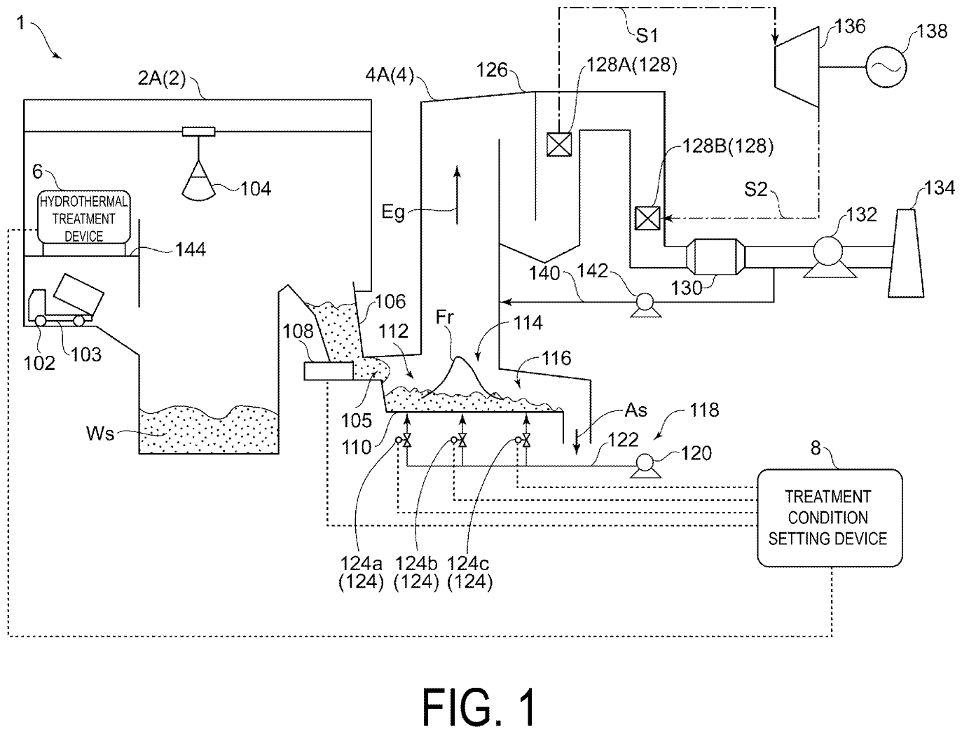

FIG. 1 is a view schematically illustrating the configuration of a waste treatment facility according to a first embodiment. The waste treatment facility is, for example, an incineration facility 1 where waste Ws such as municipal waste is incinerated. The municipal waste is composed mainly of garbage, paper waste, and plastic waste and contains a small amount of metal. The waste Ws is not limited to the municipal waste, and may be those having a percentage of water content amount larger than that of the municipal waste, such as sludge generated by treating waste water from a factory or the like and agricultural waste. In the present disclosure, a case where the waste treatment facility is the incineration facility 1 will be described as an example.

As illustrated in FIG. 1, the incineration facility 1 includes a storage unit 2, a treatment facility 4, a hydrothermal treatment device 6, and a treatment condition setting device 8.

The storage unit 2 stores the waste Ws. In the embodiment illustrated in FIG. 1, the storage unit 2 is a waste pit 2A (2), and the incineration facility 1 includes a platform 102, a crane 104, a receiving hopper 106, and a dust feeding device 108. The waste pit 2A communicates with the platform 102 and stores the waste Ws fed from the platform 102 by a garbage truck 103. Then, the crane 104 provided in the waste pit 2A feeds, into the receiving hopper 106, part of the waste Ws stored in the waste pit 2A. The dust feeding device 108 supplies, to an incinerator 4A described later, the waste Ws fed to the receiving hopper 106. Specifically, the dust feeding device 108 reciprocates so as to discharge, toward the incinerator 4A, the waste Ws fed into the receiving hopper 106, and supplies the waste Ws into the incinerator 4A through a supply port 105 formed in the incinerator 4A.

The treatment facility 4 performs intermediate treatment of part of the waste Ws stored in the storage unit 2. In the embodiment illustrated in FIG. 1, the treatment facility 4 is the incinerator 4A (4) where part of the waste Ws stored in the waste pit 2A is incinerated. In the embodiment illustrated in FIG. 1, the incinerator 4A has a cylindrical shape extending along the vertical direction and includes a grate 110 (stoker) on which the waste Ws discharged into the incinerator 4A through the supply port 105 is accumulated. The grate 110 is configured to move the waste Ws accumulated on the grate 110 in a direction away from the supply port 105. The grate 110 forms a dry region 112, a combustion region 114 and a post-combustion region 116, which are arranged in order from an upstream side to a downstream side in the movement direction of the waste Ws. The dry region 112 dries the waste Ws accumulated on the grate 110 by heat in the incinerator 4A. The combustion region 114 generates flame Fr to combust waste Ws accumulated on the grate 110. The post-combustion region 116 fully combusts any burnout not burned out in the combustion region 114. The waste Ws dried, combusted, and post-combusted in the incinerator 4A becomes ash As and is discharged to the outside of the incinerator 4A.

In the embodiment illustrated in FIG. 1, the incineration facility 1 includes an air supply device 118 that supplies the incinerator 4A with combustion air used for combustion of the waste Ws. The air supply device 118 includes a forced draft fan 120, an air supply line 122 connecting the forced draft fan 120 and the grate 110, the air supply line 122 through which the combustion air flows, and an air flow rate regulating valve 124 provided in the air supply line 122 and regulating the amount of the combustion air supplied into the incinerator 4A by the forced draft fan 120.

The forced draft fan 120 takes in combustion air from the outside of the incineration facility 1 and supplies the combustion air into the incinerator 4A from below the grate 110 via the air supply line 122. The air supply line 122 includes a plurality of air supply ports, and combustion air is supplied to each of the dry region 112, the combustion region 114, and the post-combustion region 116. The air flow rate regulating valve 124 includes a first air flow rate regulating valve 124a (124) regulating the amount of the combustion air supplied to the dry region 112, a second air flow rate regulating valve 124b (124) regulating the amount of the combustion air supplied to the combustion region 114, and a third air flow rate regulating valve 124c (124) regulating the amount of the combustion air supplied to the post-combustion region 116.

In the embodiment illustrated in FIG. 1, the incineration facility 1 is configured to treat an exhaust gas Eg generated by combustion of the waste Ws, and includes a flue gas duct 126, a heat exchanger 128, a precipitator 130, an induced draft fan 132, a stack 134, a steam turbine 136, and a generator 138.

The flue gas duct 126 is coupled to a vertical upper portion of the incinerator 4A, and the exhaust gas Eg flows therethrough. In the flow direction in which the exhaust gas Eg flows through the flue gas duct 126, the flue gas duct 126 is provided with the heat exchanger 128, the precipitator 130, and the induced draft fan 132 in order from the upstream side. A downstream end of the flue gas duct 126 is provided with the stack 134.

The heat exchanger 128 recovers heat of the exhaust gas Eg by performing heat exchange between the steam or fed water and the exhaust gas Eg. In the embodiment illustrated in FIG. 1, the heat exchanger 128 includes an upstream-side heat exchanger 128A (128) and a downstream-side heat exchanger 128B (128) disposed downstream in the flow direction of the exhaust gas Eg relative to the upstream-side heat exchanger 128A. The upstream-side heat exchanger 128A is, for example, a superheater, and the steam flowing through the upstream-side heat exchanger 128A is superheated by the exhaust gas Eg. Then, superheated steam S1 produced by the upstream-side heat exchanger 128A is supplied to the steam turbine 136 to rotationally drive the steam turbine 136. The generator 138 is coupled to the steam turbine 136 and generates electric power in response to rotation of the steam turbine 136. The downstream-side heat exchanger 128B is, for example, a reheater or an economizer, and is supplied with discharged steam S2 discharged from the steam turbine 136. The downstream-side heat exchanger 128B performs heat exchange between the discharged steam S2 and the exhaust gas Eg. Although not illustrated, the incineration facility 1 may further include a condenser, and the downstream-side heat exchanger 128B may be supplied with condensate produced by cooling the discharged steam S2 by the condenser.

The precipitator 130 collects particulate matters (fly ash) contained in the exhaust gas Eg. The induced draft fan 132 intakes the exhaust gas Eg toward the stack 134. The stack 134 discharges the exhaust gas Eg to the outside of the incineration facility 1. In the embodiment illustrated in FIG. 1, the incineration facility 1 further includes a circulation line 140 connecting the flue gas duct 126 and the incinerator 4A, and a circulation blower 142 that is provided in the circulation line 140 and circulates, to the incinerator 4A, part of the exhaust gas Eg flowing through the flue gas duct 126. The circulation line 140 is connected to a portion of the flue gas duct 126 between the precipitator 130 and the induced draft fan 132. Note that the circulation blower 142 is a forced draft fan that intakes the exhaust gas Eg from the flue gas duct 126 and pushes the exhaust gas Eg into the incinerator 4A.

The hydrothermal treatment device 6 and the treatment condition setting device 8 will be described. The hydrothermal treatment device 6 hydrolyzes remaining part of the waste Ws stored in the waste pit 2A (storage unit 2) with steam to produce a modified substance X1. In the embodiment illustrated in FIG. 1, the hydrothermal treatment device 6 is disposed on a stage 144 provided in the waste pit 2A. The hydrothermal treatment device 6 receives the waste Ws from the waste pit 2A via the crane 104 and hydrolyzes the received waste Ws in a batch manner with steam. The hydrothermal treatment device 6 may apply wet hydrolysis in which steam comes into contact with the waste Ws to heat the waste Ws, or dry hydrolysis in which steam does not come into contact with the waste Ws but indirectly heats the waste Ws. The modified substance X1 may be supplied to the incinerator 4A as described later or may be discharged to the outside of the incineration facility 1.

In some embodiments, the steam for the hydrothermal treatment device 6 to hydrolyze the remaining part of the waste Ws includes the discharged steam S2 described above. In some embodiments, the steam turbine 136 includes a high-pressure turbine supplied with the superheated steam S1 and a low-pressure turbine supplied with the superheated steam S1 flowing out of the high-pressure turbine. The steam for the hydrothermal treatment device 6 to hydrolyze the remaining part of the waste Ws includes part (extraction steam) of the superheated steam S1 flowing out of the high-pressure turbine.

In some embodiments, the hydrothermal treatment device 6 is also configured to be able to directly receive the waste Ws conveyed to the incineration facility 1. In other words, the hydrothermal treatment device 6 is also configured to be able to receive the waste Ws conveyed to the incineration facility 1 not via the waste pit 2A. Such configuration can suppress the waste Ws having large percentage of water content such as sludge, rice straw, vegetable waste, seaweed, and fish processing residues from being supplied to the incinerator 4A and can promote combustion of the waste Ws.

In some embodiments, the hydrothermal treatment device 6 may function (serve also) as the treatment facility 4 and performs intermediate treatment of part of the waste Ws stored in the storage unit 2. In this case, the intermediate treatment refers to the hydrolysis of the waste Ws by the hydrothermal treatment device 6.

The treatment condition setting device 8 acquires process data from the hydrothermal treatment device 6, estimates an index for setting an incineration condition for incinerating the waste Ws in the incinerator 4A (treatment condition for intermediate treatment of the waste Ws in the treatment facility 4) in accordance with the process data, and sets the incineration condition in accordance with this index. The treatment condition setting device 8 is a computer such as an electronic control device and includes a processor such as a CPU or a GPU, a memory such as a ROM or a RAM, and an I/O interface that are not illustrated. The treatment condition setting device 8 implements some functions of the treatment condition setting device 8 by the processor operating (calculating or the like) in accordance with a command of a program loaded in the memory. Note that the treatment condition setting device 8 may be a cloud server provided in a cloud environment.

In the embodiment illustrated in FIG. 1, the treatment condition setting device 8 is electrically connected to each of the hydrothermal treatment device 6, the dust feeding device 108, the first air flow rate regulating valve 124a, the second air flow rate regulating valve 124b, and the third air flow rate regulating valve 124c. The treatment condition setting device 8 sets the reciprocating speed of the dust feeding device 108 such that the amount of the waste Ws in accordance with the index estimated from the process data of the hydrothermal treatment device 6 is supplied to the incinerator 4A. Furthermore, the treatment condition setting device 8 sets the degree of opening of each of the first air flow rate regulating valve 124a, the second air flow rate regulating valve 124b, and the third air flow rate regulating valve 124c such that the amount of combustion air in accordance with the index estimated from the process data of the hydrothermal treatment device 6 is supplied to the incinerator 4A.

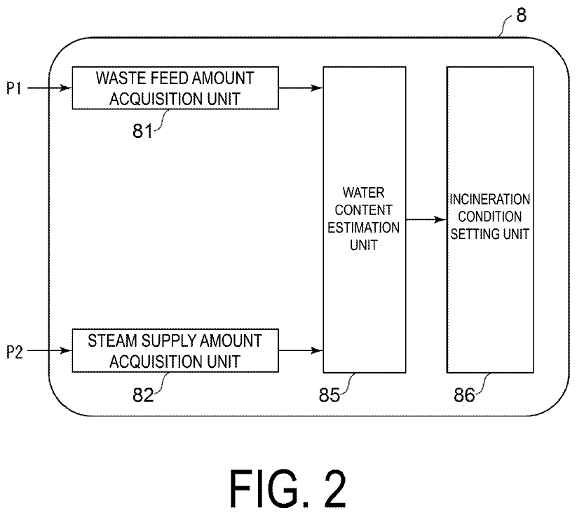

An example of estimation of an index by the treatment condition setting device 8 will be described. FIG. 2 is a schematic functional block diagram of the treatment condition setting device 8 according to the first embodiment. As illustrated in FIG. 2, the treatment condition setting device 8 includes a waste feed amount acquisition unit 81 that acquires the amount of the waste Ws to be fed to the hydrothermal treatment device 6 (hereinafter, waste feed amount P1), a steam supply amount acquisition unit 82 that acquires the amount of steam to be supplied to the hydrothermal treatment device 6 (hereinafter, steam supply amount P2) to produce the modified substance X1 from the waste Ws fed to the hydrothermal treatment device 6, a percentage of water content estimation unit 85 that estimates the percentage of water content of the waste Ws in accordance with the waste feed amount P1 and the steam supply amount P2, and an incineration condition setting unit 86 that sets an incineration condition in accordance with the percentage of water content of the waste Ws having been estimated by the percentage of water content estimation unit 85.

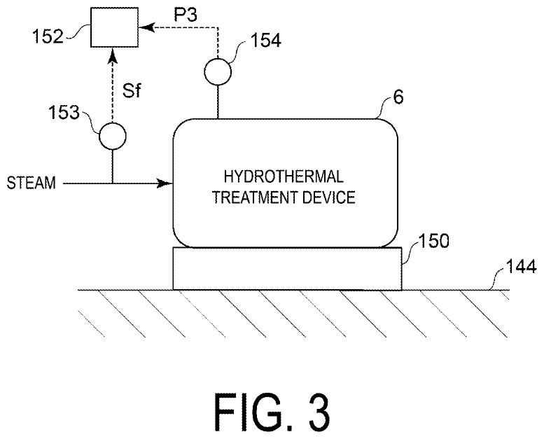

Each of the waste feed amount P1 and the steam supply amount P2 is process data of the hydrothermal treatment device 6. FIG. 3 is a view for describing an example of the configuration for acquiring each of the waste feed amount P1 and the steam supply amount P2 according to the first embodiment. In the embodiment illustrated in FIG. 3, the incineration facility 1 further includes a waste amount acquisition device 150 that acquires the waste feed amount P1 (amount of waste) and a steam amount acquisition device 152 that acquires the steam supply amount P2 (amount of steam). The waste amount acquisition device 150 is, for example, a load cell, and acquires, as the waste feed amount P1, a difference between the weight of the hydrothermal treatment device 6 after fed with the waste Ws and the weight of the hydrothermal treatment device 6 before fed with the waste Ws. The steam amount acquisition device 152 acquires, from a flow meter 153, a flow rate Sf of the steam flowing through a pipe for supplying the steam to the hydrothermal treatment device 6, for example, and acquires, from a timer 154, the temperature increase time (hereinafter, temperature increase time P3) during which the temperature of the waste Ws fed into the hydrothermal treatment device 6 is increased by the steam to a predetermined increased temperature T. The steam amount acquisition device 152 then acquires the steam supply amount P2 by multiplying the flow rate Sf of the steam by the temperature increase time P3.

The percentage of water content estimation unit 85 stores a heat balance equation including the waste feed amount P1 (symbol Min in Equation (1)) and the steam supply amount P2 (symbol Mst_in in Equation (1)), and estimates the percentage of water content of the waste Ws by inputting the waste feed amount P1 and the steam supply amount P2 into the heat balance equation. The heat balance equation is represented by Equation (1) by which fed waste and a reaction vessel are heated with the latent heat (and sensible heat) of the steam to be fed.

$$Q = Min \cdot ( 1 - Win ) \cdot Cp\_so \cdot ( TH - Tin ) + Min \cdot Win \cdot Cp\_w \cdot ( TH - Tin ) + Mr \cdot Cp\_r \cdot ( TH - Tr 0 ) = Mst\_in \cdot Lst \qquad ( 1 )$$

Here, Q represents the total heat amount fed to the hydrothermal treatment device 6, Min represents the weight of the fed waste Ws, Win represents the percentage of water content of the fed waste Ws, Cp_so represents the solid specific heat of the waste Ws set from an actual result, TH represents the treatment temperature for hydrolyzing the waste Ws, Tin represents the feed temperature of the waste Ws, Cp_w represents the specific heat of water, Mr represents the weight of the hydrothermal treatment device 6, Cp_r represents the specific heat of the hydrothermal treatment device 6, Tr0 represents the initial temperature of the hydrothermal treatment device 6, Mst_in represents the weight of steam, and Lst represents the latent heat of steam (value in consideration of sensible heat up to TH).

Each of Min, TH, Tin, Mr (reactor vessel weight is measured only in the first time), and Mst_in is a process measurement value, and each of Cp_so, Cp_w, Cp_r, and Lst is a preset physical property value. That is, since the unknown is only Win, the percentage of water content Win of the fed waste Ws can be calculated as in Equation (2).

$$Win = \{ Mst\_in \cdot Lst - Min \cdot Cp\_so \cdot ( TH - Tin ) - Mr \cdot Cp\_r \cdot ( TH - Tr 0 ) \} / \{ - Min \cdot ( TH - Tin ) \cdot ( Cp\_so - Cp\_w ) \} \qquad ( 2 )$$

At the time of actual operation, it is also possible to obtain the percentage of water content Win of the fed waste as in Equation (3) by substituting Mst_in=Fst·t, which uses steam flow rate Fst and steam feed time t, into Equation (2). Note that t represents the temperature increase time P3.

$$Win = \{ Fst \cdot t \cdot Lst - Min \cdot Cp\_so \cdot ( TH - Tin ) - Mr \cdot Cp\_r \cdot ( TH - Tr 0 ) \} / \{ - Min \cdot ( TH - Tin ) \cdot ( Cp\_so - Cp\_w ) \} \qquad ( 3 )$$

When the percentage of water content of 47.2% (true value) of a measured value was estimated by the present method, the estimated value became 45.2%, which was in good agreement.

Based on the percentage of water content of the waste Ws estimated by the percentage of water content estimation unit 85, the incineration condition setting unit 86 sets each of the reciprocating speed of the dust feeding device 108, the degree of opening of the first air flow rate regulating valve 124a, the degree of opening of the second air flow rate regulating valve 124b, and the degree of opening of the third air flow rate regulating valve 124c. For example, the incineration condition setting unit 86 stores a map in which the reciprocating speed of the dust feeding device 108, the degree of opening of the first air flow rate regulating valve 124a, the degree of opening of the second air flow rate regulating valve 124b, and the degree of opening of the third air flow rate regulating valve 124c are associated with the percentage of water content of the waste Ws, and, based on this map, sets each of the reciprocating speed of the dust feeding device 108, the degree of opening of the first air flow rate regulating valve 124a, the degree of opening of the second air flow rate regulating valve 124b, and the degree of opening of the third air flow rate regulating valve 124c.

### Actions and Effects of First Embodiment

The incineration condition is set based on the property of the waste Ws such as the lower calorific value or the percentage of water content of the waste Ws. According to the findings of the present inventors, the property of the waste Ws can be estimated from process data of the hydrothermal treatment device 6.

According to the first embodiment, the incineration facility 1 includes the hydrothermal treatment device 6 that produces the modified substance X1 by hydrolyzing part of the waste Ws stored in the waste pit 2A with steam, and the treatment condition setting device 8 that sets the incineration condition for incinerating the waste Ws in the incinerator 4A in accordance with the process data of the hydrothermal treatment device 6. Since this enables the property of the waste Ws to be estimated before the waste Ws is incinerated in the incinerator 4A, and the incineration condition for incinerating the waste Ws in the incinerator 4A to be set in advance, the incinerator 4A can be operated under an appropriate incineration condition, and the operating state of the incinerator 4A can be stabilized.

When the period and the area for collecting the waste Ws are the same, the variation range of the physical property values (e.g., brought-in moisture content of paper, specific heat of plastic, and the like) of paper waste and plastic waste included in the waste Ws is small. However, the ratio of paper waste and plastic waste included in the waste Ws changes day to day. That is, the percentage of water content of the waste Ws changes day to day. According to the first embodiment, the percentage of water content of the waste Ws is estimated before the waste Ws is incinerated in the incinerator 4A, the incineration condition of the incinerator 4A is set based on the percentage of water content of the waste Ws. Therefore, the operating state of the incinerator 4A can be stabilized.

Since the waste Ws is heterogeneous, it is not easy to set an incineration condition from the waste Ws. However, according to the first embodiment, since the modified substance X1 is a large amount of the waste Ws with reduced volume, the incineration condition is set from the large amount of the waste Ws. That is, the incineration condition can be set with a greatly improved accuracy of the incineration condition.

According to the first embodiment, since the incineration condition includes both the amount of the waste Ws and the amount of the combustion air that are supplied to the incinerator 4A, the amount of the waste Ws and the amount of the combustion air that are supplied to the incinerator 4A are set in advance before the waste Ws is incinerated in the incinerator 4A, and the incinerator 4A can be operated with an appropriate amount of the waste Ws and an appropriate amount of the combustion air and the operating state of the incinerator 4A can be stabilized.

In the first embodiment, the incineration condition includes both the amount of the waste Ws and the amount of the combustion air that are supplied to the incinerator 4A, but the present disclosure is not limited to this embodiment. In some embodiments, the incineration condition includes any one of the amount of the waste Ws and the amount of the combustion air that are supplied to the incinerator 4A. In some embodiments, the incineration condition comprises the movement speed of the grate 110. In some embodiments, the incineration conditions include the amount of the exhaust gas Eg circulated to the incinerator 4A. In this case, the treatment condition setting device 8 sets the rotational speed of the fan of the circulation blower 142, for example.

According to the first embodiment, before the waste Ws is incinerated in the incinerator 4A, the treatment condition setting device 8 can estimate the percentage of water content of the waste Ws using the heat balance equation, and can set in advance the amount of the waste Ws and the amount of combustion air that are supplied to the incinerator 4A based on the percentage of water content of the waste Ws.

Note that in the first embodiment, the treatment condition setting device 8 estimates the percentage of water content of the waste Ws, which is one of the indices, in accordance with the heat balance equation including the waste feed amount P1 (amount of the waste Ws) and the steam supply amount P2 (amount of steam), but the present disclosure is not limited to this embodiment.

### Second Embodiment

The incineration facility 1 according to the second embodiment of the present disclosure will be described. The second embodiment is different from the first embodiment in being further provided with a composition identification device 10, but the other configurations are the same as the configurations described in the first embodiment. In the second embodiment, the same components as those of the first embodiment are denoted by the same reference signs, and the detailed description thereof will be omitted.

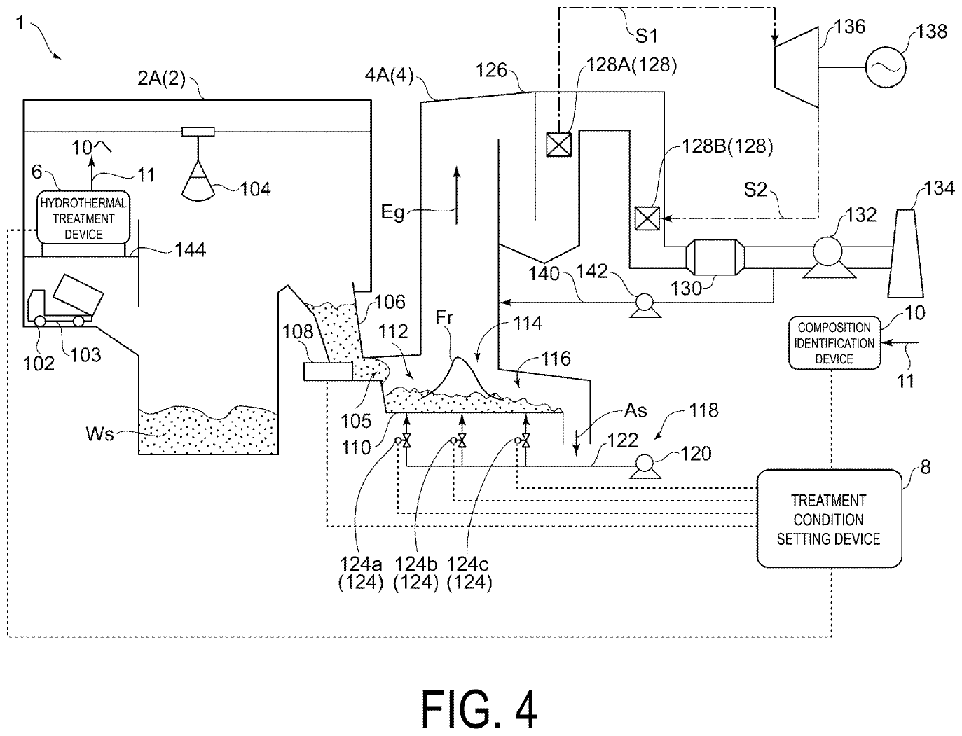

FIG. 4 is a view schematically illustrating the configuration of the incineration facility 1 according to the second embodiment. As illustrated in FIG. 4, the incineration facility 1 further includes the composition identification device 10.

### Configuration of Composition Identification Device

The composition identification device 10 identifies the composition of the modified substance X1 produced by the hydrothermal treatment device 6. In the embodiment illustrated in FIG. 4, the composition identification device 10 is configured to receive the modified substance X1 produced by the hydrothermal treatment device 6 through a connection line 11 connected to the hydrothermal treatment device 6. The composition identification device 10 is electrically connected to the treatment condition setting device 8. The treatment condition setting device 8 acquires the composition of the modified substance X1 identified by the composition identification device 10 as process data of the hydrothermal treatment device 6. Then, the treatment condition setting device 8 estimates the percentage of water content of the waste Ws, which is one of the indices, in accordance with the composition of the modified substance X1. Note that composition identification device 10 may be disposed on the stage 144 provided in the waste pit 2A together with the hydrothermal treatment device 6.

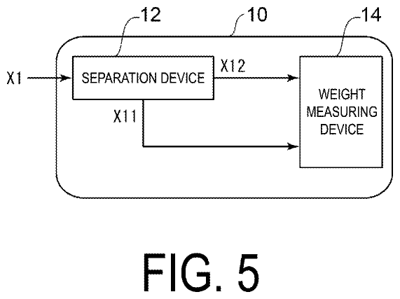

A specific configuration of the composition identification device 10 according to the second embodiment will be described. FIG. 5 is a view schematically illustrating the configuration of the composition identification device 10 according to the second embodiment. As illustrated in FIG. 5, the composition identification device 10 includes a separation device 12 and a weight measuring device 14.

The separation device 12 separates the modified substance X1 into a large particle size component X11 and a small particle size component X12, which has a particle size smaller than that of the large particle size component X11. The separation device 12 is a screen having an arbitrary mesh size, for example, and the mesh size corresponds to the particle size of a boundary between the large particle size component X11 and the small particle size component X12. The large particle size component X11 is high in calorific value and low in percentage of water content, and is, for example, plastic waste. The small particle size component X12 is low in calorific value and high in percentage of water content, and is, for example, food, paper, vegetation, and the like. Note that the separation device 12 may include a plurality of screens having different mesh sizes.

The weight measuring device 14 measures each of the weight of the large particle size component X11 and the weight of the small particle size component X12. Then, the composition identification device 10 identifies the composition of the modified substance X1 from the weight of the large particle size component X11 and the weight of the small particle size component X12. As a specific example, assuming that the weight of the large particle size component X11 is 70 g and the weight of the small particle size component X12 is 30 g, the composition identification device 10 identifies that the modified substance X1 has a composition in which the large particle size component X11 is 70% and the small particle size component X12 is 30%. Although not illustrated, in some embodiments, the incineration facility 1 further includes a methane fermentation device configured to ferment the small particle size component X12 with methane, and the weight measuring device 14 measures the weight of the small particle size component X12 subjected to the methane fermentation by the methane fermentation device.

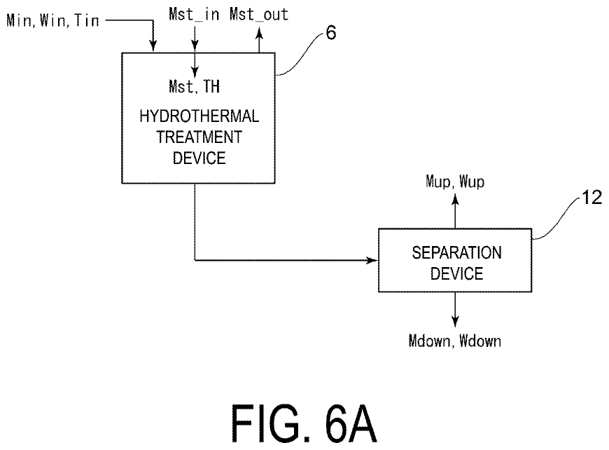

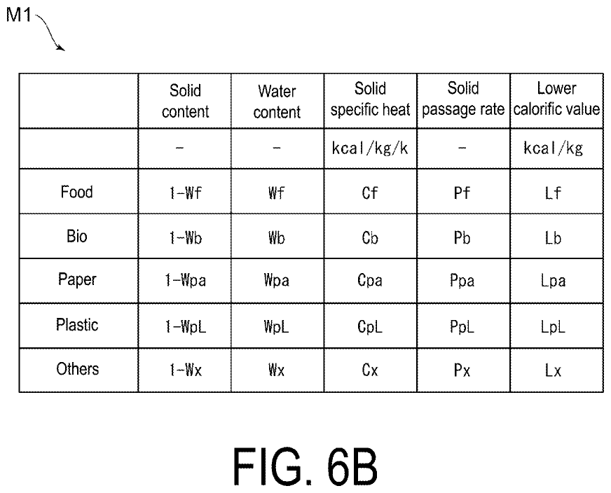

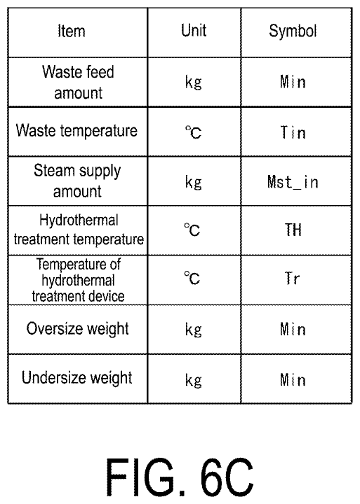

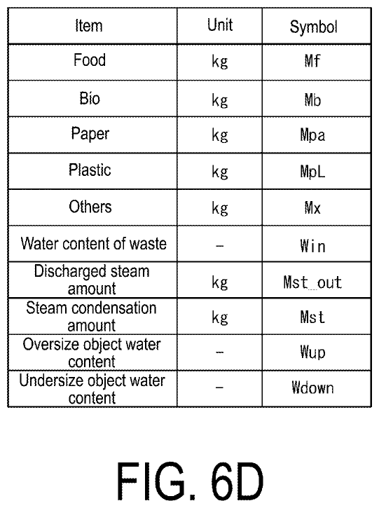

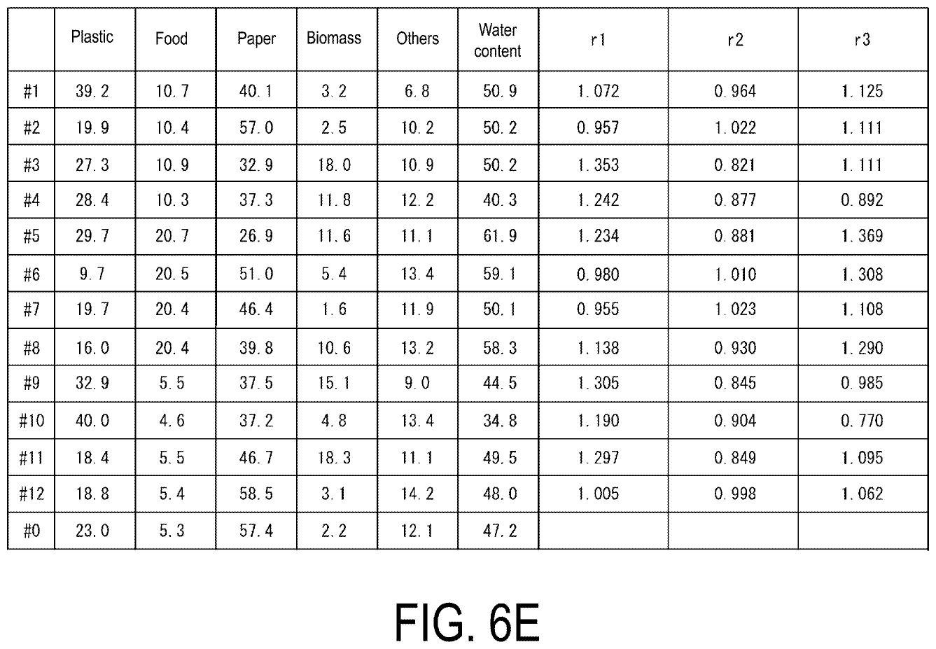

Here, an estimation method for the composition (waste composition) of the waste Ws will be described. FIG. 6A is a view illustrating a model of a hydrothermal treatment balance equation according to the second embodiment. FIG. 6B is a view illustrating a first map M1 according to the second embodiment. FIG. 6C is a view illustrating a list of process measurement values according to the second embodiment. FIG. 6D is a view illustrating a list of unknowns according to the second embodiment. The first map M1 is created in advance, and indicates the solid content, the percentage of water content, the solid specific heat, the solid passage rate through the screen, and the lower calorific value for the food/bio/paper/plastic/others constituting the waste Ws.

At the time of composition estimation, in accordance with the mass balance and the heat balance indicated in the model of the hydrothermal treatment balance equation illustrated in FIG. 6A, the weight of each composition is calculated by associating, with the first map M1, the process measurement value acquired as data. From the viewpoints of the overall mass balance, the water balance, the heat balance, the on-screen (non-passing object) mass balance, and the under-screen (passing object) mass balance, the following 10 balance Equations (Equations (4) to (13)) are established, and unknowns can be solved. As an example, there is a method of determining an unknown so that the sum of squares of the left side−the right side of each equation is minimized using known data of a similar waste Ws composition as an initial value.

### Overall Mass Balance

$$Min + Mst = Mup + Mdown \qquad ( 4 )$$

$$Min = Mf + Mb + Mpa + MpL + Mx \qquad ( 5 )$$

### Water Balance

$$Win \cdot Min = Wf \cdot Mf + Wb \cdot Mb + Wpa \cdot Mpa + WpL \cdot MpL + Wx \cdot Mx \qquad ( 6 )$$

$$Min \cdot Win + Mst = Mup \cdot Wup + Mdown \cdot Wdown \qquad ( 7 )$$

$$Mst = Mst\_in - Mst\_out \qquad ( 8 )$$

### Heat Balance

$$Q = Mf \cdot ( 1 - Wf ) \cdot Cf \cdot ( TH - Tin ) + Mf \cdot Wf \cdot Cp\_W \cdot ( TH - Tin ) + Mb \cdot ( 1 - Wb ) \cdot Cb \cdot ( TH - Tin ) + Mb \cdot Wb \cdot Cp\_W \cdot ( TH - Tin ) + Mpa \cdot ( 1 - Wpa ) \cdot Cpa \cdot ( TH - Tin ) + Mpa \cdot Wpa \cdot Cp\_W \cdot ( TH - Tin ) + MpL \cdot ( 1 - WpL ) \cdot CpL \cdot ( TH - Tin ) + MpL \cdot WpL \cdot Cp\_W \cdot ( TH - Tin ) + Mx \cdot ( 1 - Wx ) \cdot Cx \cdot ( TH - Tin ) + Mx \cdot Wx \cdot Cp\_W \cdot ( TH - Tin ) + Mr \cdot Cp\_r \cdot ( TH - Tr 0 ) = Mst\_in \cdot Lst \qquad ( 9 )$$

### On-Screen (Non-Passing Object) Mass Balance

$$Mup = ( Mf \cdot ( 1 - Wf ) \cdot ( 1 - Pf ) + Mb \cdot ( 1 - Wb ) \cdot ( 1 - Pb ) + Mpa \cdot ( 1 - Wpa ) \cdot ( 1 - Ppa ) ) \times A + MpL \cdot ( 1 - WpL ) \cdot ( 1 - PpL ) + Mx \cdot ( 1 - Wx ) \cdot ( 1 - Px ) \qquad ( 10 )$$

$$Wup = ( Mf \cdot ( 1 - Wf ) \cdot ( 1 - Pf ) + Mb \cdot ( 1 - Wb ) \cdot ( 1 - Pb ) + Mpa \cdot ( 1 - Wpa ) \cdot ( 1 - Ppa ) ) \times ( A - 1 ) / Mup \qquad ( 11 )$$

### Under-Screen (Passing Object) Mass Balance

$$Mdown = ( Mf \cdot ( 1 - Wf ) \cdot Pf + Mb \cdot ( 1 - Wb ) \cdot Pb + Mpa \cdot ( 1 - Wpa ) \cdot Ppa ) \times A + MpL \cdot ( 1 - WpL ) \cdot PpL + Mx \cdot ( 1 - Wx ) \cdot Px \qquad ( 12 )$$

$$Wdown = ( Mf \cdot ( 1 - Wf ) \cdot Pf + Mb \cdot ( 1 - Wb ) \cdot Pb + Mpa \cdot ( 1 - Wpa ) \cdot Ppa ) \times ( A - 1 ) / Mdown \qquad ( 13 )$$

Assuming that moisture is uniformly distributed to solids of food, bio, and paper after the hydrothermal treatment, A=1+(Min·Win+Mst)/(Mf·(1−Wf)+Mb·(1−Wb)+Mpa·(1−Wpa) may be satisfied. The lower calorific value of the waste Ws can also be obtained from the weight, percentage of water content, and lower calorific value of each composition of the waste Ws.

A result of estimating the composition and the percentage of water content of the waste Ws using the present method will be described. FIG. 6E is a view illustrating a result of estimating the composition and the percentage of water content of the waste Ws according to the second embodiment. As illustrated in FIG. 6E, a plurality of pieces of the waste Ws (#1 to #12 in FIG. 6E) whose composition (mass ratio of each of plastic, food, paper, biomass, and others in FIG. 6E) and percentage of water content are measured in advance, and the waste Ws for testing (#0 in FIG. 6E) are prepared. Then, for each of the plurality of pieces of the waste Ws, a prediction value of the weight on the screen (non-passing object), a prediction value of the weight under the screen (passing object), and a prediction value of the percentage of water content are calculated using the above-described method. Then, a measured value of the weight on the screen of the waste Ws for testing, a measured value of the weight under the screen, and a measured value of the percentage of water content are measured. FIG. 6E illustrates a ratio (r1 in FIG. 6E) in which the prediction value of the weight on the screen is divided by the measured value, a ratio (r2 in FIG. 6E) in which the prediction value of the weight under the screen is divided by the measured value, and a ratio (r3 in FIG. 6E) in which the prediction value of the percentage of water content is divided by the measured value. The closer to one the ratio is, the smaller an error from the waste Ws (#0) for testing is. Regarding each of the ratios, #12 has the smallest error from #0. The percentage of water content of #0 was 47.2% and the percentage of water content of #12 was 48.0%. Regarding the composition, for example, the paper of #0 was 57.4% and the paper of #12 was 58.5%, and the compositions of #0 and #12 were very similar.

### Actions and Effects of Second Embodiment

According to the second embodiment, before the waste Ws is incinerated in the incinerator 4A, the percentage of water content of the waste Ws can be estimated in accordance with the composition of the modified substance X1 identified by the composition identification device 10, and the incineration condition can be set in advance based on the percentage of water content of the waste Ws.

Although the method using the heat balance equation and the method using the composition of the modified substance X1 have been described as the method by which the treatment condition setting device 8 estimates the percentage of water content of the waste Ws, the treatment condition setting device 8 may be configured to be applied with only one of these methods or may be configured to be applied with a plurality of methods.

The composition of the waste Ws can be analogized from the weight of the large particle size component X11 and the weight of the small particle size component X12 (composition of the modified substance X1). According to the second embodiment, before the waste Ws is incinerated in the incinerator 4A, the composition of the waste Ws is analogized from the weight of the large particle size component X11 and the weight of the small particle size component X12 separated by the separation device 12, the percentage of water content of the waste Ws is estimated based on the composition of the waste Ws, and the incineration condition can be set in advance based on the percentage of water content of the waste Ws.

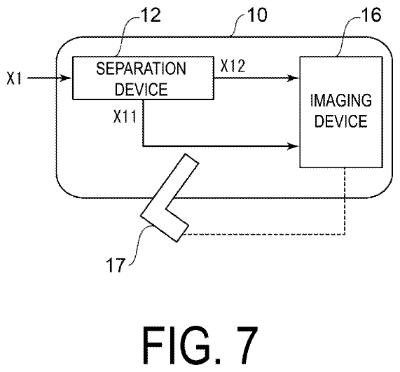

A modification example of the second embodiment will be described. FIG. 7 is a view schematically illustrating the configuration of the composition identification device 10 according to the modification example of the second embodiment. As illustrated in FIG. 7, the composition identification device 10 includes the separation device 12 and an imaging device 16. In the modification example of the second embodiment, the same components as those of the second embodiment are denoted by the same reference signs, and the detailed description thereof will be omitted.

The imaging device 16 is a device that can acquire image information corresponding to a plurality of wavelengths, and is, for example, a multispectral camera or a hyperspectral camera. The imaging device 16 can image not only a visible light region but also a near infrared region. In the embodiment illustrated in FIG. 7, the imaging device 16 images both of the large particle size component X11 and the small particle size component X12. Then, the composition identification device 10 identifies the composition of the modified substance X1 from the image information. As a specific example, the image information in which the large particle size component X11 is imaged includes an image of plastic corresponding to a predetermined wavelength region, and the composition identification device 10 estimates the weight of the plastic from this image information. Similarly, the image information in which the small particle size component X12 is imaged includes images of food, paper, and biomass corresponding to a predetermined wavelength region, and the composition identification device 10 estimates the weights of the food, the paper, and the biomass from this image information. The composition identification device 10 then identifies the composition of the modified substance X1 from the weights of the plastic, the food, paper, and the biomass.

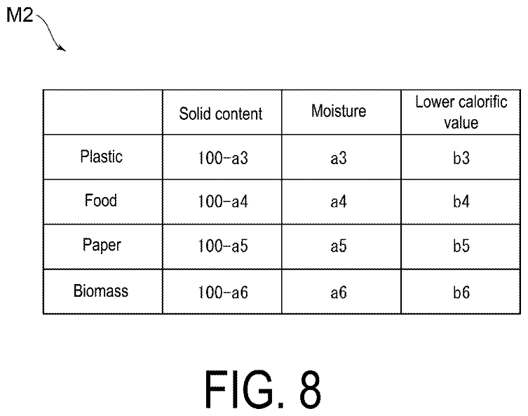

Here, estimation of the percentage of water content of the waste Ws from the composition of the modified substance X1 by the treatment condition setting device 8 will be described. FIG. 8 is a view illustrating a second map M2 according to a modification example of the second embodiment. The second map M2 indicates each of the solid content, the moisture, and the lower calorific value of the waste Ws for each composition. As illustrated in FIG. 8, the second map M2 includes solid content 100-a3, moisture a3, and a lower calorific value b3 of plastic, solid content 100-a4, moisture a4, and a lower calorific value b4 of food, solid content 100-a5, moisture a5, and a lower calorific value b5 of paper, and solid content 100-a6, moisture a6, and a lower calorific value b6 of biomass. Each of the solid content and the moisture is indicated by ratio. The lower calorific value is a lower calorific value per predetermined weight. The second map M2 is stored in advance by the treatment condition setting device 8.

The percentage of water content estimation unit 85 of the treatment condition setting device 8 estimates the percentage of water content of the waste Ws by analogizing and associating, with the second map M2, the composition of the modified substance X1 identified from the image information as the composition of the waste Ws. In some embodiments, the treatment condition setting device 8 estimates the lower calorific value of the waste Ws in accordance with the composition of the modified substance X1 identified from the image information. Specifically, by analogizing and associating, with the second map M2 described above, the composition of the modified substance X1 identified from the image information as the composition of the waste Ws, the treatment condition setting device 8 estimates the lower calorific value of the waste Ws.

According to the modification example of the second embodiment, the composition of each of the large particle size component X11 and the small particle size component X12 can be further classified with high accuracy, and the estimation accuracy of the percentage of water content of the waste Ws by the treatment condition setting device 8 can be enhanced.

In the embodiment illustrated in FIG. 7, the composition identification device 10 includes a removing device 17 that removes a component corresponding to a predetermined wavelength from the large particle size component X11 in accordance with image information imaged by the imaging device 16. The removing device 17 removes vinyl chloride from the large particle size component X11 by, for example, irradiating the large particle size component X11 on the screen with compressed air. In some embodiments, the removing device 17 removes a component corresponding to a predetermined wavelength from the small particle size component X12. In some embodiments, the removing device 17 removes components corresponding to predetermined wavelengths from both the large particle size component X11 and the small particle size component X12. Note that the component removed by the removing device 17 is not limited to vinyl chloride.

According to the modification example of the second embodiment, in a case where the imaging device 16 includes a hyperspectral camera, vinyl chloride (PVC) derived from Cl can be detected for a non-passing object on the screen. Specifically, a near infrared reflection spectrum of PVC is measured by the hyperspectral camera, and the content of the PVC is estimated from the ratio of the PVC in the screen. By taking advantage of a feature of being able to identify only PVC on the screen (non-passing object), it is possible to install a sorter (removing device 17) on a downstream stage of the screen and remove only PVC by irradiating the PVC with compressed air, and it is possible to reuse the removed PVC as PVC and to make other plastic into high-quality RPF or reuse it. Since the large particle size component X11 from which PVC is removed is supplied to the incinerator 4A, corrosion of the flue gas duct 126 and the like due to PVC can be suppressed.

According to the modification example of the second embodiment, it is possible to estimate the content of Cu, Zn, and Pb by grasping, by image processing using AI, the abundance of an electronic circuit board and a coated wire derived from Cu. Specifically, the characteristics of the electronic circuit board are extracted with a visible camera or a terahertz camera, the type, size, and quantity of the electronic circuit board are identified from the ratio in the screen, and the weight of Cu/Zn/Pb in the waste is grasped by using a preset weight ratio of Cu/Zn/Pb included therein.

According to the modification example of the second embodiment, the content of S, Na, K, Zn, and Pb can be estimated by performing fluorescence X-ray image analysis on powder for a screen-passing object. Since the treated object having passed through the screen is homogeneous powder, it is possible to acquire representative data of the non-uniform waste Ws that is difficult to acquire representative data. Since many salts are water-soluble, it is also possible to grasp the content of Na and K by measuring, using an ion meter, separated water in which the powder is washed with water and separated.

In the modification example of the second embodiment, the imaging device 16 images both the large particle size component X11 and the small particle size component X12, but the present disclosure is not limited to this embodiment. In some embodiments, the imaging device 16 images any one of the large particle size component X11 and the small particle size component X12.

In some embodiments, the incineration condition (treatment condition) includes a component and amount of an additive to be added to the exhaust gas Eg (generation target) generated by incineration (intermediate treatment) of the waste Ws. The exhaust gas Eg may contain a component that damages a flow facility through which the exhaust gas Eg flows. For example, factors affecting boiler wastage at an incinerator outlet include corrosion due to a fly ash adhering component, and corrosion is promoted by components such as Cl, S, Na, K, Cu, Zn, and Pb derived from waste Ws. In order to suppress the boiler corrosion speed and extend the boiler life, it is necessary to promptly take a corrosion countermeasure in accordance with the amount of these components mixed into the waste Ws. According to some embodiments, since the incineration condition includes the component and amount of the additive added to the exhaust gas Eg, damage on the incinerator outlet or the like can be suppressed. Removing the electronic circuit board, the coated wire, and the like before incinerating the waste Ws allows the boiler life to be further extended. The generation target generated by the incineration (intermediate treatment) of the waste Ws is not limited to the exhaust gas Eg and may be a solid.

In the second embodiment, the treatment condition setting device 8 acquires the composition of the modified substance X1 as process data from the composition identification device 10, but the present disclosure is not limited to this embodiment. In some embodiments, the composition of the modified substance X1 may be used as an index for setting the treatment condition. In this case, the composition of the modified substance X1 is estimated (identified) from the weight of the large particle size component X11 and the weight of the small particle size component X12. That is, the composition of the modified substance X1, which is an index, is estimated from the weight of the large particle size component X11 and the weight of the small particle size component X12, which are process data. The composition of such the modified substance X1 is a ratio of plastic, for example.

### Third Embodiment

The incineration facility 1 according to the third embodiment of the present disclosure will be described. The third embodiment is different from the second embodiment in being further provided with a supply device 18, but the other configurations are the same as the configurations described in the second embodiment. In the third embodiment, the same components as those of the second embodiment are denoted by the same reference signs, and the detailed description thereof will be omitted. The incineration facility 1 according to some embodiments is one in which the supply device 18 is added to the incineration facility 1 of the first embodiment.

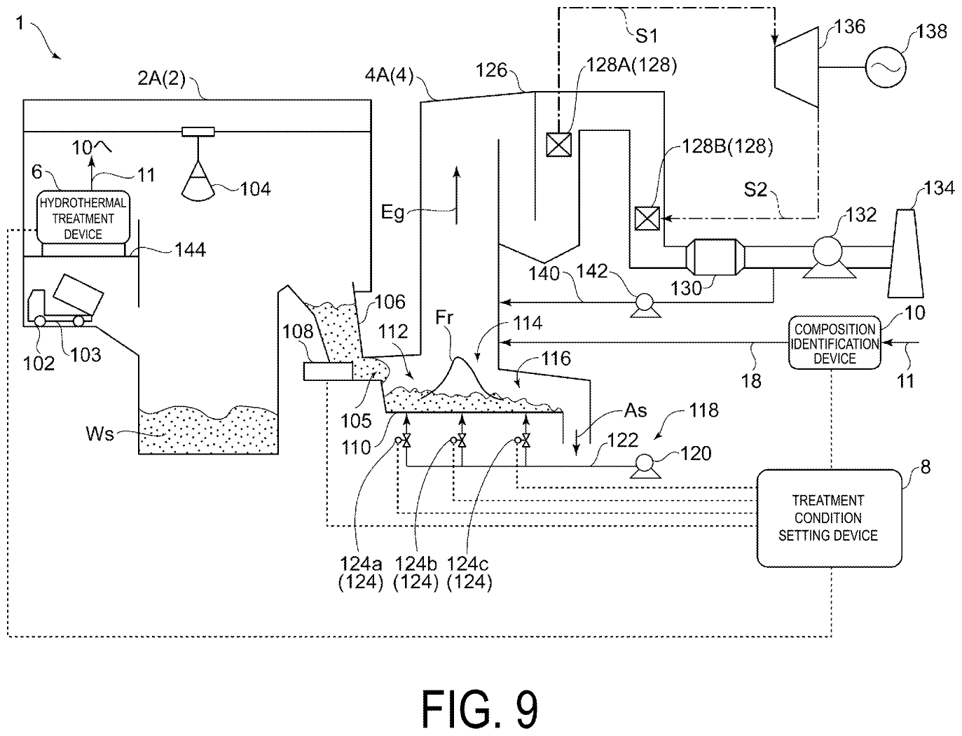

FIG. 9 is a view schematically illustrating the configuration of the incineration facility 1 according to the third embodiment. As illustrated in FIG. 9, the incineration facility 1 further includes the supply device 18.

### Configuration of Supply Device

The supply device 18 supplies the modified substance X1 from the hydrothermal treatment device 6 to the incinerator 4A. In the embodiment illustrated in FIG. 9, the supply device 18 supplies the modified substance X1 whose composition is identified by the composition identification device 10 to the incinerator 4A. A supply port of the modified substance X1 formed in the incinerator 4A is positioned on the combustion region 114, and the incinerator 4A is configured to be able to rapidly combust the modified substance X1. The supply device 18 may be, for example, a pipe that connects the composition identification device 10 and the incinerator 4A, the pipe through which the modified substance X1 flows, or may be a belt conveyor that moves the modified substance X1 discharged from the composition identification device 10 to the incinerator 4A.

In some embodiments, the supply port of the modified substance X1 is positioned on the dry region 112 and the incinerator 4A is configured to dry and then combust the modified substance X1 together with the waste Ws. In some embodiments, the supply device 18 supplies the incinerator 4A with the large particle size component X11 separated from the modified substance X1 by the separation device 12 of the composition identification device 10. In some embodiments, the supply device 18 supplies the incinerator 4A with the small particle size component X12 separated from the modified substance X1 by the separation device 12 of the composition identification device 10.

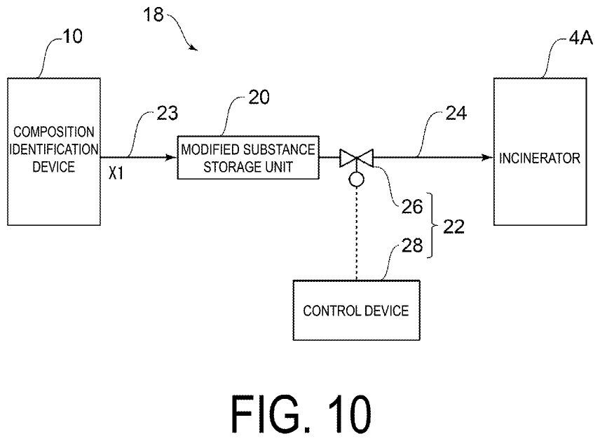

A specific configuration of the supply device 18 according to the third embodiment will be described. FIG. 10 is a view schematically illustrating the configuration of the supply device 18 according to the third embodiment. As illustrated in FIG. 10, the supply device 18 includes a modified substance storage unit 20 and an adjustment device 22. The modified substance storage unit 20 is configured to be able to store the modified substance X1, and is, for example, a tank. The adjustment device 22 is configured to adjust the amount of the modified substance X1 supplied from the modified substance storage unit 20 to the incinerator 4A. In some embodiments, the modified substance storage unit 20 is zoned in the waste pit 2A and includes a space in which the modified substance X1 can be stored.

In the embodiment illustrated in FIG. 10, the supply device 18 includes an upstream-side line 23 connecting the composition identification device 10 and the modified substance storage unit 20, and a downstream-side line 24 connecting the modified substance storage unit 20 and the incinerator 4A. The modified substance X1 flows through the upstream-side line 23, the modified substance storage unit 20, and the downstream-side line 24 in this order and is supplied to the incinerator 4A.

The modified substance storage unit 20 receives, through the upstream-side line 23, and stores the modified substance X1 discharged from the composition identification device 10. The adjustment device 22 includes a control valve 26 provided on the downstream-side line 24, and a control device 28 that is electrically connected to the control valve 26 and adjusts the degree of opening of the control valve 26. The control device 28 is, for example, a computer, and includes a processor such as a CPU or a GPU, a memory such as a ROM or a RAM, and an I/O interface that are not illustrated. The control device 28 implements some functions of the control device 28 by the processor operating (calculating or the like) in accordance with a command of a program loaded in the memory. The control device 28 is configured to be able to acquire the operating state of the incinerator 4A such as the concentration of nitrogen oxide (NOx) contained in the exhaust gas Eg and adjusts the degree of opening of the control valve 26 in accordance with the concentration of NOx. In some embodiments, the control device 28 is a cloud server provided in a cloud environment.

An example of the operation of the hydrothermal treatment device 6 and the supply device 18 in the incineration facility 1 according to the third embodiment will be described. When the amount of the waste Ws stored in the waste pit 2A exceeds a predetermined threshold value, the hydrothermal treatment device 6 receives, via the crane 104, the remaining part of the waste Ws stored in the waste pit 2A, and hydrolyzes the waste Ws with steam to produce the modified substance X1. The supply device 18 stores the modified substance X1 produced by the hydrothermal treatment device 6 in the modified substance storage unit 20. Note that in a case where the supply device 18 includes a detour device 30 described later, a detour-side modified substance storage unit 32 (detour-side tank) may store, in place of the modified substance storage unit 20 or together with the modified substance storage unit 20, the modified substance X1 produced by the hydrothermal treatment device 6.

Although not illustrated, the incineration facility 1 includes a monitoring device that monitors whether or not the amount of the waste Ws stored in the waste pit 2A exceeds the threshold value. The monitoring device monitors, for example, whether or not the waste Ws stored in the waste pit 2A exceeds a predetermined height. The hydrothermal treatment device 6 is electrically connected to the monitoring device, and automatically starts reception of the waste Ws (switching an on-off valve of the hydrothermal treatment device 6 to open) when the amount of the waste Ws stored in the waste pit 2A exceeds the predetermined height (threshold value). In some embodiments, the hydrothermal treatment device 6 starts reception of the waste Ws at an instruction of a worker.

### Actions and Effects of Third Embodiment

According to the third embodiment, since the supply device 18 supplies the modified substance X1 to the incinerator 4A, the incinerator 4A can incinerate the modified substance X1 as fuel. Furthermore, according to the third embodiment, since the adjustment device 22 adjusts the amount of the modified substance X1 to be supplied to the incinerator 4A in accordance with the operating state of the incinerator 4A, the operating state of the incinerator 4A can be stabilized.

In the incineration facility 1, the waste Ws that is too excessive to be incinerated in the incinerator 4A is sometimes conveyed due to a disaster such as a typhoon. According to the third embodiment, when the amount of the waste Ws stored in the waste pit 2A exceeds the threshold value, the waste Ws is treated by the hydrothermal treatment device 6 in addition to the incinerator 4A. Therefore, the incineration facility 1 can receive the excessive waste Ws.

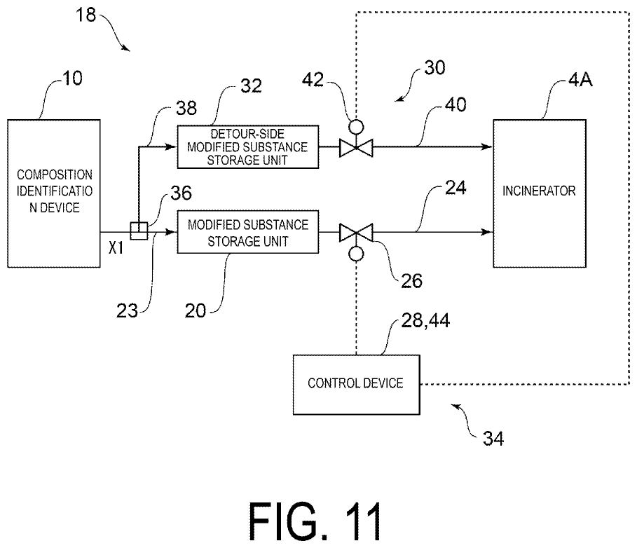

A modification example of the third embodiment will be described. FIG. 11 is a view schematically illustrating the configuration of the supply device 18 according to the modification example of the third embodiment. As illustrated in FIG. 11, the supply device 18 further includes the detour device 30 that supplies the modified substance X1 to the incinerator 4A while detouring the modified substance storage unit 20. In the modification example of the third embodiment, the same components as those of the third embodiment are denoted by the same reference signs, and the detailed description thereof will be omitted.

The detour device 30 includes the detour-side modified substance storage unit 32 that can store the modified substance X1, a detour-side adjustment device 34 that can adjust the amount of the modified substance X1 supplied from the detour-side modified substance storage unit 32 to the incinerator 4A, and a switching device 36 configured to switch between the modified substance storage unit 20 and the detour-side modified substance storage unit 32 for storage of the modified substance X1 in accordance with the percentage of water content of the modified substance X1. Note that the detour-side modified substance storage unit 32 may have any configuration as long as it can store the modified substance X1, and is, for example, a tank. In some embodiments, the detour-side modified substance storage unit 32 is zoned in the waste pit 2A and includes a space in which the modified substance X1 can be stored. When each of the modified substance storage unit 20 and the detour-side modified substance storage unit 32 is zoned in the waste pit 2A, the switching device 36 may be the crane 104.

In the embodiment illustrated in FIG. 11, the detour device 30 includes an upstream-side diverging line 38 diverging from the upstream-side line 23 and connected to the detour-side modified substance storage unit 32, and a downstream-side diverging line 40 connecting the detour-side modified substance storage unit 32 and the incinerator 4A. The modified substance X1 flows through the upstream-side diverging line 38, the detour-side modified substance storage unit 32, and the downstream-side diverging line 40 in this order and is supplied to the incinerator 4A. In some embodiments, the downstream-side diverging line 40 connects the detour-side modified substance storage unit 32 and the downstream-side line 24. That is, the incinerator 4A is configured such that the supply port of the modified substance X1 stored in the detour-side modified substance storage unit 32 and the supply port of the modified substance X1 stored in the modified substance storage unit 20 become common.

The switching device 36 is provided at a diverging portion where the upstream-side diverging line 38 diverges from the upstream-side line 23. The switching device 36 is configured to be able to acquire the amount of moisture contained in the modified substance X1. For example, the switching device 36 acquires the amount of moisture contained in the modified substance X1 from a moisture meter provided on the composition identification device 10 side (upstream side) of the upstream-side line 23 relative to the switching device 36. The switching device 36 switches storage of the modified substance X1 to the modified substance storage unit 20 when the acquired percentage of water content of the modified substance X1 is larger than a predetermined amount, and switches storage of the modified substance X1 to the detour-side modified substance storage unit 32 when the acquired percentage of water content of the modified substance X1 is smaller than the predetermined amount.

The detour-side modified substance storage unit 32 receives. through the upstream-side diverging line 38, and stores the modified substance X1 having a small percentage of water content discharged from the composition identification device 10. The detour-side adjustment device 34 includes a detour-side control valve 42 provided in the downstream-side diverging line 40, and a detour-side control device 44 electrically connected to the detour-side control valve 42 and adjusting the degree of opening of the detour-side control valve 42. In the embodiment illustrated in FIG. 11, the control device 28 described above is configured to function as the detour-side control device 44. In some embodiments, each of the control device 28 and the detour-side control device 44 is a separate body from each other.

For example, when the incinerator 4A is supplied with the waste Ws that is excessive, in order to suppress combustion of the waste Ws, the control device 28 opens the control valve 26 and closes the detour-side control valve 42, and supplies the incinerator 4A with the modified substance X1 having a large percentage of water content stored in the modified substance storage unit 20. On the other hand, when the incinerator 4A is supplied with the waste Ws having a high percentage of water content, in order to promote combustion of the waste Ws, the control device 28 closes the control valve 26 and opens the detour-side control valve 42, and supplies the incinerator 4A with the modified substance X1 having a low percentage of water content stored in the detour-side modified substance storage unit 32.

According to the modification example of the third embodiment, since the modified substance X1 having different percentage of water content can be supplied to the incinerator 4A in accordance with the operating state of the incinerator 4A, the operating state of the incinerator 4A can be further stabilized.

### Fourth Embodiment

The incineration facility 1 according to the fourth embodiment of the present disclosure will be described. The fourth embodiment is different from the third embodiment in being further provided with two incinerators 4A, but the other configurations are the same as the configurations described in the third embodiment. In the fourth embodiment, the same components as those of the third embodiment are denoted by the same reference signs, and the detailed description thereof will be omitted.

### Configuration of Incineration Facility

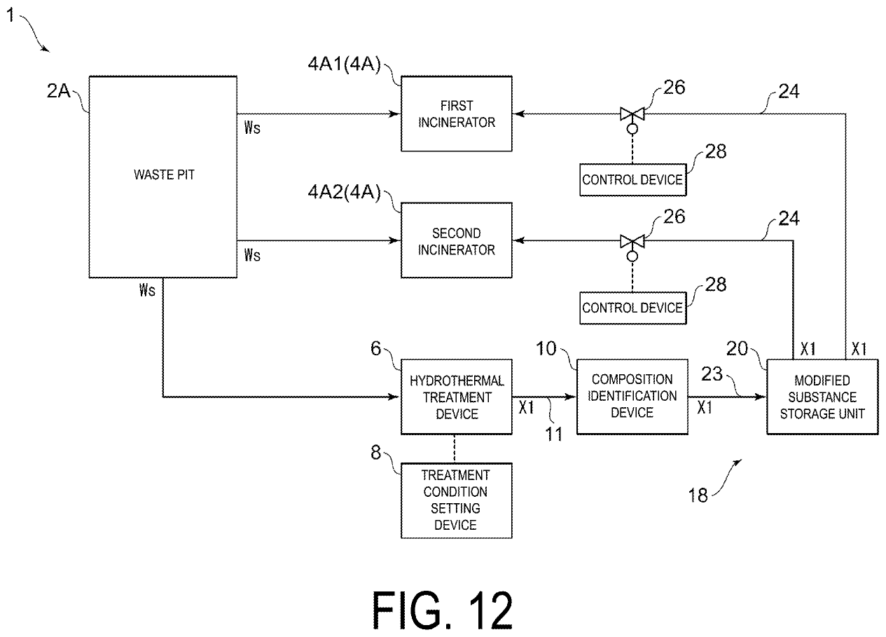

FIG. 12 is a view schematically illustrating the configuration of the incineration facility 1 according to the fourth embodiment. As illustrated in FIG. 12, the incineration facility 1 includes a first incinerator 4A1 (4A) and a second incinerator 4A2 (4A). Each of the first incinerator 4A1 and the second incinerator 4A2 incinerates part of the waste Ws stored in the common waste pit 2A. In the embodiment illustrated in FIG. 12, each of the first incinerator 4A1 and the second incinerator 4A2 is configured to be supplied with the modified substance X1 stored in the common modified substance storage unit 20.

An example of the operation of the hydrothermal treatment device 6 and the supply device 18 in the incineration facility 1 according to the fourth embodiment will be described. When the operation of any one of the first incinerator 4A1 and the second incinerator 4A2 is stopped, the hydrothermal treatment device 6 hydrolyzes remaining part of the waste Ws stored in the waste pit 2A with steam to produce the modified substance X1. The supply device 18 stores the modified substance X1 produced by the hydrothermal treatment device 6 in the modified substance storage unit 20. Furthermore, in a case where both the first incinerator 4A1 and the second incinerator 4A2 are returned to the operating state after the modified substance X1 is stored, the supply device 18 supplies the modified substance X1 stored in the modified substance storage unit 20 to at least one of the first incinerator 4A1 or the second incinerator 4A2. Note that in a case where the supply device 18 includes the detour device 30, the detour-side modified substance storage unit 32 may store, in place of the modified substance storage unit 20 or together with the modified substance storage unit 20, the modified substance X1 produced by the hydrothermal treatment device 6.

Although not illustrated, the incineration facility 1 includes an operation monitoring device that monitors whether or not each of the first incinerator 4A1 and the second incinerator 4A2 is in operation. The hydrothermal treatment device 6 is electrically connected to the operation monitoring device, and automatically starts reception of the waste Ws (switching an on-off valve of the hydrothermal treatment device 6 to open) when the operation of any one of the first incinerator 4A1 and the second incinerator 4A2 is stopped. In some embodiments, the hydrothermal treatment device 6 starts reception of the waste Ws at an instruction of a worker. The supply device 18 is electrically connected to the operation monitoring device, and automatically starts supply of the modified substance X1 (switches the control valve 26 to open) when both the first incinerator 4A1 and the second incinerator 4A2 are returned to the operating state. In some embodiments, the supply device 18 starts supply of the modified substance X1 at an instruction of a worker.

### Actions and Effects of Fourth Embodiment

The incineration facility 1 includes the first incinerator 4A1 and the second incinerator 4A2 and is configured to be capable of two-incinerator operation in many cases. In this case, when the operation of any one of the first incinerator 4A1 and the second incinerator 4A2 is stopped due to periodic maintenance or the like, the amount of the waste Ws stored in the waste pit 2A increases. For this reason, it has been necessary to adjust the timing of one-incinerator operation.

According to the fourth embodiment, in one-incinerator operation, the hydrothermal treatment device 6 hydrolyzes the remaining part of the waste Ws stored in the waste pit 2A with steam to produce the modified substance X1, and the supply device 18 stores the modified substance X1 in the modified substance storage unit 20. That is, at the time of one-incinerator operation, volume reduction by producing the modified substance X1 from the waste Ws can be performed, and an increase in the amount of the waste Ws stored in the waste pit 2A can be suppressed. Therefore, one-incinerator operation can be used at any timing. Furthermore, since the modified substance X1 is sterilized, unlike the waste Ws, the modified substance X1 does not decay or is very unlikely to decay. Therefore, in one-incinerator operation, the modified substance X1 is produced and stored in the modified substance storage unit 20, whereby generation of offensive odor can be suppressed.

The incineration facility 1 is sometimes configured to produce steam with thermal energy of the exhaust gas Eg. In this case, the steam production efficiency by the incineration facility 1 is often higher in a case of two-incinerator operation than in a case of one-incinerator operation. According to the fourth embodiment, the modified substance X1 is stored in the modified substance storage unit 20 at the time of low-efficiency one-incinerator operation, and the modified substance X1 stored in the modified substance storage unit 20 is supplied to the incinerator 4A at the time of high-efficiency two-incinerator operation. Therefore, the steam production efficiency by the incineration facility 1 can be enhanced.

Note that in the embodiment described above, a case where the treatment facility 4 is the incinerator 4A has been described as an example, but the present disclosure is not limited to this embodiment. The treatment facility 4 can be applied to various waste treatment facilities such as a carbonization furnace, a fuel facility, methane fermentation, and composting fermentation, the treatment facility 4 can optimize the operation by grasping the properties of feedstocks in advance, and can stabilize the operation by stockpiling and supplying, in a timely manner, the treated object.

For example, when the treatment facility 4 is a sludge fuel facility, steam is released until an appropriate percentage of water content is obtained before the treated object is discharged from the hydrothermal treatment device 6, but when the percentage of water content of the fed feedstock is unknown, the steam release amount cannot be set. At present, the percentage of water content of the feedstock is manually measured by a method of evaporation to dryness, but it takes time and labor, and the feedstock is not homogeneous in many cases, and it has been difficult to acquire representative data. When the steam release amount is large, the percentage of water content decreases and the viscosity of the treated object increases, which causes occlusion. When the steam release amount is small, the percentage of water content increases and the load of dewatering and drying of the following stage increases. Applying the present technology enables the percentage of water content to be grasped during hydrothermal treatment after the feedstock is fed, and the steam release amount to be optimized and discharged at an appropriate viscosity.

The contents described in the above embodiments is understood as follows, for example.

[1] A waste treatment facility (1) according to the present disclosure includes:
a storage unit (2) configured to store waste (Ws);
at least one treatment facility (4) configured to perform intermediate treatment of part of the waste stored in the storage unit;
a hydrothermal treatment device (6) configured to hydrolyze remaining part of the waste stored in the storage unit with steam to produce a modified substance (X1); and
a treatment condition setting device (8) configured to acquire process data of the hydrothermal treatment device, estimate an index for setting a treatment condition for intermediate treatment of the waste in the at least one treatment facility in accordance with the process data, and set the treatment condition in accordance with the index.

The treatment condition is set in accordance with the property of the waste. According to the findings of the present inventors, the property of the waste can be estimated from process data of the hydrothermal treatment device that hydrolyzes the waste with steam. According to the configuration described in the above [1], the waste treatment facility according to the present disclosure includes the hydrothermal treatment device configured to hydrolyze part of the waste stored in the storage unit with steam to produce a modified substance and the treatment condition setting device configured to set a treatment condition for intermediate treatment of the waste in the treatment facility in accordance with process data of the hydrothermal treatment device. Thus, before intermediate treatment of the waste in the treatment facility, the property of the waste can be estimated, and the treatment condition for intermediate treatment of the waste in the treatment facility can be set in advance. This can operate the treatment facility under an appropriate treatment condition and stabilize the operating state of the treatment facility.

[2] In some embodiments, in the configuration described in the above [1],
the index includes percentage of water content of the waste,
the process data includes an amount (P1) of the waste to be fed to the hydrothermal treatment device and an amount (P2) of steam to be supplied to the hydrothermal treatment device to produce the modified substance from the waste fed to the hydrothermal treatment device,
a waste amount acquisition device (150) configured to acquire an amount of the waste and a steam amount acquisition device (152) configured to acquire the amount of the steam are further included, and
the treatment condition setting device estimates the percentage of water content of the waste in accordance with a heat balance equation including the amount of the waste and the amount of the steam.

The treatment condition is often set in accordance with the percentage of water content of the waste among the properties of the waste. The configuration described in the above [2] can estimate, before intermediate treatment of the waste in the treatment facility, the percentage of water content of the waste and set in advance the treatment condition in accordance with the percentage of water content of the waste.

[3] In some embodiments, the configuration described in the above [1] or [2] further includes
a composition identification device (10) configured to identify a composition of the modified substance,
the index includes at least one of percentage of water content of the waste or a lower calorific value of the waste,
the process data includes the composition of the modified substance identified by the composition identification device, and
the treatment condition setting device estimates the at least one of the percentage of water content of the waste or the lower calorific value of the waste in accordance with the composition of the modified substance.

The treatment condition may be set in accordance with the at least one of the percentage of water content of the waste or the lower calorific value of the waste among the properties of the waste. According to the findings of the present inventors, each of the percentage of water content of the waste and the lower calorific value of the waste can be estimated in accordance with the composition of the modified substance. The configuration described in the above [3] can estimate, before intermediate treatment of the waste in the treatment facility, the at least one of the percentage of water content of the waste or the lower calorific value of the waste in accordance with the composition of the modified substance and set in advance the treatment condition in accordance with the estimated value.

[4] In some embodiments, in the configuration described in the above [3],
the composition identification device includes
a separation device (12) configured to separate the modified substance into a large particle size component (X11) and a small particle size component (X12) having a particle size smaller than a particle size of the large particle size component.

The composition of the waste can be analogized from the weight of the large particle size component of the modified substance and the weight of the small particle size component of the modified substance. The configuration described in the above [4] can analogize, before intermediate treatment of the waste in the treatment facility, the composition of the waste from the weight of the large particle size component and the weight of the small particle size component separated by the separation device, estimate the at least one of the percentage of water content of the waste or the lower calorific value of the waste in accordance with the composition of this waste, and set in advance the treatment condition in accordance with the estimated value.

[5] In some embodiments, in the configuration described in the above [4],
the composition identification device
includes an imaging device (16) that can image at least one of the large particle size component or the small particle size component and acquire image information corresponding to a plurality of wavelengths and
classifies, from the image information of the imaging device, the at least one of the large particle size component or the small particle size component into a plurality of compositions, and
the treatment condition setting device estimates the at least one of the percentage of water content of the waste or the lower calorific value of the waste in accordance with the plurality of compositions of the at least one of the large particle size component or the small particle size component.

The configuration described in the above [5] can classify the composition of each of the large particle size component and the small particle size component with higher accuracy and enhance the estimation accuracy of the percentage of water content of the waste and the lower calorific value of the waste by the treatment condition setting device.

[6] In some embodiments, in the configuration described in the above [5].
the composition identification device includes
a removing device (17) configured to remove a component corresponding to a predetermined wavelength from the at least one of the large particle size component or the small particle size component in accordance with the image information.

The configuration described in the above [6] can suppress an influence on the waste treatment facility (e.g., promotion of boiler corrosion by vinyl chloride) caused by the component corresponding to the predetermined wavelength being included in the large particle size component or the small particle size component. A component removed from the large particle size component or the small particle size component can be reused.

[7] In some embodiments, in the configuration described in any one of the above [3] to [6], the treatment condition setting device sets the treatment condition in accordance with the at least one of the percentage of water content of the waste or the lower calorific value of the waste, and the treatment condition includes a component and an amount of an additive to be added to a generation target generated by intermediate treatment of the waste.

Some of devices constituting the waste treatment facility may be damaged by the generation target. For example, when the generation target is a reaction gas, it may contain a component that damages a flow facility (e.g., flue gas duct of boiler) through which the reaction gas flows. According to the configuration described in the above [7], the treatment condition includes the component and amount of the additive to be added to the generation target, allowing damage to the devices constituting the waste treatment facility to be suppressed.

[8] In some embodiments, the configuration described in the above [1] or [2] further includes
a composition identification device configured to identify a composition of the modified substance, and
the index includes the composition of the modified substance.

The configuration described in the above [8] can set the treatment condition in accordance with the composition of the modified substance.

[9] In some embodiments, the configuration described in any one of the above [1] to [8] further includes
a supply device (18) configured to supply the modified substance from the hydrothermal treatment device to the at least one treatment facility.

The configuration described in the above [8] can perform intermediate treatment of the modified substance.

[10] In some embodiments, in the configuration described in the above [9]
the supply device includes
a modified substance storage unit (20) that can store the modified substance and
an adjustment device (22) that can adjust an amount of the modified substance to be supplied from the modified substance storage unit to the at least one treatment facility.

The configuration described in the above [10] can adjust the amount of the modified substance to be supplied to the treatment facility in accordance with the operating state of the treatment facility and thus stabilize the operating state of the treatment facility.

[11] In some embodiments, in the configuration described in the above [10],
the supply device further includes
a detour device (30) configured to detour the modified substance storage unit to supply the modified substance to the treatment facility.

The detour device includes
a detour-side modified substance storage unit (32) that can store the modified substance,
a detour-side adjustment device (34) that can adjust an amount of the modified substance to be supplied from the detour-side modified substance storage unit to the treatment facility, and
a switching device (36) configured to switch between the modified substance storage unit and the detour-side modified substance storage unit for storage of the modified substance in accordance with percentage of water content of the modified substance.

The configuration described in the above [11] can supply the modified substance having different percentage of water content to the treatment facility in accordance with the operating state of the treatment facility and thus further stabilize the operating state of the treatment facility.

[12] In some embodiments, in the configuration described in the above [10] or [11],
the hydrothermal treatment device is configured to hydrolyze, when an amount of the waste stored in the storage unit exceeds a predetermined threshold value, remaining part of the waste stored in the storage unit with the steam to produce the modified substance, and
the supply device is configured to store, when the amount of the waste stored in the storage unit exceeds a predetermined threshold value, the modified substance in the modified substance storage unit.

Excess waste is sometimes conveyed to the treatment facility. For example, when the treatment facility is an incinerator of an incineration facility, waste that is too excessive to be incinerated in the incinerator is sometimes conveyed due to a disaster such as a typhoon. According to the configuration described in the above [12], when the amount of the waste stored in the storage unit exceeds the threshold value, the hydrothermal treatment device hydrolyzes the remaining part of the waste to produce the modified substance, and the supply device stores the modified substance in the modified substance storage unit. That is, the waste is treated by the hydrothermal treatment device in addition to the treatment facility. Accordingly, the incineration facility can receive excess waste.

[13] In some embodiments, in the configuration described in any one of the above [1] to [12],
the at least one treatment facility includes at least one incinerator (4A) configured to incinerate part of the waste stored in the storage unit.

The configuration described in the above [13] allows the configurations of the above [1] to [10] to be applied to an incinerator. That is, before intermediate treatment (incineration) of the waste in the incinerator, the property of the waste can be estimated, and a treatment condition (incineration condition) for incinerating the waste in the incinerator can be set in advance. This can operate the incinerator under an appropriate incineration condition and stabilize the operating state of the incinerator.

[14] In some embodiments, in the configuration described in the above [13],
the treatment condition includes at least one of an amount of the waste to be supplied to the at least one incinerator or an amount of combustion air to be supplied to the at least one incinerator.

The configuration described in the above can set in advance, before incinerating the waste in the incinerator, the at least one of the amount of the waste or the amount of the combustion air to be supplied to the incinerator, operate the incinerator with an appropriate amount of the waste and an appropriate amount of the combustion air, and stabilize the operating state of the incinerator.

[15] In some embodiments, the configuration described in the above [13] or [14] further includes
a supply device configured to supply the modified substance from the hydrothermal treatment device to the at least one incinerator and including a modified substance storage unit that can store the modified substance and an adjustment device that can adjust an amount of the modified substance to be supplied from the modified substance storage unit to the at least one incinerator.

The at least one incinerator includes a first incinerator (4A1) and a second incinerator (4A2),
the hydrothermal treatment device is configured to hydrolyze, when operation of any one of the first incinerator and the second incinerator is stopped, remaining part of the waste stored in the storage unit with the steam to produce the modified substance, and
the supply device is configured to store, when the operation of any one of the first incinerator and the second incinerator is stopped, the modified substance in the modified substance storage unit.

When the treatment facility is an incinerator, the treatment facility includes the first incinerator and the second incinerator and is capable of two-incinerator operation in many cases. In this case, when the operation of any one of the first incinerator and the second incinerator is stopped due to periodic maintenance or the like, the amount of the waste stored in the storage unit increases. For this reason, it has been necessary to adjust the timing of one-incinerator operation. According to the configuration described in the above [15], in one-incinerator operation, the hydrothermal treatment device hydrolyzes the remaining part of the waste stored in the storage unit with steam to produce the modified substance, and the supply device stores the modified substance in a storage tank. That is, an increase in the amount of the waste stored in the storage unit can be suppressed during one-incinerator operation. Therefore, one-incinerator operation can be used at any timing.

[16] In some embodiments, in the configuration described in the above [15],
the supply device is configured to supply, when both the first incinerator and the second incinerator are returned to an operating state, the modified substance stored in the modified substance storage unit to at least one of the first incinerator or the second incinerator.

When the waste treatment facility includes the incinerator, the waste treatment facility is sometimes configured to produce steam with thermal energy of exhaust gas generated by incineration of waste or a modified substance. In this case, the steam production efficiency by the waste treatment facility is often higher in a case of two-incinerator operation than in a case of one-incinerator operation. According to the configuration described in the above [15], the modified substance is stored in the modified substance storage unit at the time of low-efficiency one-incinerator operation, and the modified substance stored in the modified substance storage unit is supplied to at least one of the first incinerator or the second incinerator at the time of high-efficiency two-incinerator operation. This can enhance the steam production efficiency by the waste treatment facility.

[17] In some embodiments, in the configuration described in any one of the above [1] to [12],
the at least one treatment facility is a carbonization furnace configured to carbonize part of the waste stored in the storage unit, a fuel facility configured to convert part of the waste stored in the storage unit into fuel, a methane fermentation facility configured to ferment part of the waste stored in the storage unit with methane, or a composting fermentation facility configured to compost and ferment part of the waste stored in the storage unit.

The configuration described in the above [17] allows the configurations of the above [1] to [10] to be applied to each of the carbonization furnace, the fuel facility, the methane fermentation facility, and the composting fermentation facility. That is, before intermediate treatment (carbonization, converting to fuel, methane fermentation, or composting fermentation) of the waste in each of these treatment facilities, the property of the waste can be estimated, and the treatment condition for intermediate treatment of the waste in each of these treatment facilities can be set in advance. This can operate each of these treatment facilities under an appropriate treatment condition and stabilize the operating state of each of these treatment facilities.

### REFERENCE SIGNS LIST

1 Waste treatment facility
2 Storage unit
4 Treatment facility
4A Incinerator
4A1 First incinerator
4A2 Second incinerator
6 Hydrothermal treatment device
8 Treatment condition setting device
10 Composition identification device
12 Separation device
16 Imaging device
17 Removing device
18 Supply device
20 Modified substance storage unit
22 Adjustment device
30 Detour device
32 Detour-side modified substance storage unit
34 Detour-side adjustment device
36 Switching device
P1 Waste feed amount
P2 Steam supply amount
P3 Temperature increase time
T Increased temperature
Ws Waste
X1 Modified substance
X11 Large particle size component
X12 Small particle size component

1. A waste treatment facility, comprising:
a storage unit configured to store waste;
at least one treatment facility configured to perform intermediate treatment of part of the waste stored in the storage unit;
a hydrothermal treatment device configured to hydrolyze remaining part of the waste stored in the storage unit with steam to produce a modified substance; and
a treatment condition setting device configured to:
acquire process data of the hydrothermal treatment device,
estimate an index for setting a treatment condition for intermediate treatment of the waste in the at least one treatment facility in accordance with the process data, and
set the treatment condition in accordance with the index.

2. The waste treatment facility according to claim 1, wherein
the index includes percentage of water content of the waste,
the process data includes an amount of the waste to be fed to the hydrothermal treatment device and an amount of steam to be supplied to the hydrothermal treatment device to produce the modified substance from the waste fed to the hydrothermal treatment device,
the waste treatment facility further comprises:
a waste amount acquisition device configured to acquire the amount of the waste; and
a steam amount acquisition device configured to acquire the amount of the steam, and
the treatment condition setting device estimates the percentage of water content of the waste in accordance with a heat balance equation including the amount of the waste and the amount of the steam.

3. The waste treatment facility according to claim 1, further comprising:
a composition identification device configured to identify a composition of the modified substance, wherein
the index includes at least one of percentage of water content of the waste or a lower calorific value of the waste,
the process data includes the composition of the modified substance identified by the composition identification device, and
the treatment condition setting device estimates the at least one of the percentage of water content of the waste or the lower calorific value of the waste in accordance with the composition of the modified substance.

4. The waste treatment facility according to claim 3, wherein the composition identification device includes a separation device configured to separate the modified substance into a large particle size component and a small particle size component having a particle size smaller than a particle size of the large particle size component.

5. The waste treatment facility according to claim 4, wherein
the composition identification device:
further includes an imaging device that images at least one of the large particle size component or the small particle size component and acquires image information corresponding to a plurality of wavelengths, and
classifies, from the image information of the imaging device, the at least one of the large particle size component or the small particle size component into a plurality of compositions, and
the treatment condition setting device estimates the at least one of the percentage of water content of the waste or the lower calorific value of the waste in accordance with the plurality of compositions of the at least one of the large particle size component or the small particle size component.

6. The waste treatment facility according to claim 5, wherein the composition identification device further includes a removing device configured to remove a component corresponding to a predetermined wavelength from the at least one of the large particle size component or the small particle size component in accordance with the image information.

7. The waste treatment facility according to claim 3, wherein
the treatment condition setting device sets the treatment condition in accordance with the at least one of the percentage of water content of the waste or the lower calorific value of the waste, and
the treatment condition includes a component and an amount of an additive to be added to a generation target generated by intermediate treatment of the waste.

8. The waste treatment facility according to claim 1, further comprising:
a composition identification device configured to identify a composition of the modified substance, wherein
the index includes the composition of the modified substance.

9. The waste treatment facility according to claim 1, further comprising:
a supply device configured to supply the modified substance from the hydrothermal treatment device to the at least one treatment facility.

10. The waste treatment facility according to claim 9, wherein the supply device includes:
a modified substance storage unit that stores the modified substance; and
an adjustment device that adjusts an amount of the modified substance to be supplied from the modified substance storage unit to the at least one treatment facility.

11. The waste treatment facility according to claim 10, wherein
the supply device further includes a detour device configured to detour the modified substance storage unit to supply the modified substance to the treatment facility, and
the detour device includes:
a detour-side modified substance storage unit that stores the modified substance;
a detour-side adjustment device that adjusts an amount of the modified substance to be supplied from the detour-side modified substance storage unit to the treatment facility; and
a switching device configured to switch between the modified substance storage unit and the detour-side modified substance storage unit for storage of the modified substance in accordance with percentage of water content of the modified substance.

12. The waste treatment facility according to claim 10, wherein
the hydrothermal treatment device is configured to hydrolyze, when an amount of the waste stored in the storage unit exceeds a predetermined threshold value, remaining part of the waste stored in the storage unit with the steam to produce the modified substance, and
the supply device is configured to store, when the amount of the waste stored in the storage unit exceeds the predetermined threshold value, the modified substance in the modified substance storage unit.

13. The waste treatment facility according to claim 1, wherein the at least one treatment facility includes at least one incinerator configured to incinerate part of the waste stored in the storage unit.

14. The waste treatment facility according to claim 13, wherein the treatment condition includes at least one of an amount of the waste to be supplied to the at least one incinerator or an amount of combustion air to be supplied to the at least one incinerator.

15. The waste treatment facility according to claim 13, further comprising:
a supply device configured to supply the modified substance from the hydrothermal treatment device to the at least one incinerator and comprising a modified substance storage unit that stores the modified substance and an adjustment device that adjusts an amount of the modified substance to be supplied from the modified substance storage unit to the at least one incinerator, wherein
the at least one incinerator includes a first incinerator and a second incinerator,
the hydrothermal treatment device is configured to hydrolyze, when operation of any one of the first incinerator and the second incinerator is stopped, remaining part of the waste stored in the storage unit with the steam to produce the modified substance, and
the supply device is configured to store, when the operation of any one of the first incinerator and the second incinerator is stopped, the modified substance in the modified substance storage unit.

16. The waste treatment facility according to claim 15, wherein the supply device is configured to supply, when both the first incinerator and the second incinerator are returned to an operating state, the modified substance stored in the modified substance storage unit to at least one of the first incinerator or the second incinerator.

17. The waste treatment facility according to claim 1, wherein the at least one treatment facility is:
a carbonization furnace configured to carbonize part of the waste stored in the storage unit,
a fuel facility configured to convert part of the waste stored in the storage unit into fuel,
a methane fermentation facility configured to ferment part of the waste stored in the storage unit with methane, or
a composting fermentation facility configured to compost and ferment part of the waste stored in the storage unit.
